(19) United States
(12) Patent Application Publication
(10) Pub. No.: US 2014/0214703 A1
(43) Pub. Date: Jul. 31, 2014

(54) System and Method for Acquiring Targeted Data from a Computing Device Using a Programmed Data Processing Apparatus

(71) Applicant: Robert D. Moody, Plantation, FL (US)

(72) Inventor: Robert D. Moody, Plantation, FL (US)

(73) Assignee: Robert D. Moody, Plantation, FL (US)

(21) Appl. No.: 14/166,409

(22) Filed: Jan. 28, 2014

Related U.S. Application Data
(60) Provisional application No. 61/757,611, filed on Jan. 28, 2013.

(51) Int. Cl. G06F 17/30; G06Q 50/18

(52) U.S. Cl. CPC G06F 17/30386; G06Q 50/18
USPC 705/311; 707/758

(57) ABSTRACT

A computer-implemented method for acquiring targeted data stored in a computing device using a data acquiring apparatus is provided. The method includes coupling the computing device to the data acquiring apparatus, and displaying a user interface on a screen associated with the computing device, wherein the user interface lists a plurality of data acquiring programs. The method further includes detecting a designation of a particular drive of the computing device following the user selection of one of a plurality of data acquiring programs, activating the selected data acquiring program to search in the designated particular drive for a data entity that corresponds to a search function of the selected data acquiring program, generating a copy of the data entity if found by the search, and submitting the copied data entity to a folder in the data acquiring apparatus for further processing.

### REFERENCE TO RELATED APPLICATIONS

The present application claims priority under 35 U.S.C. §119(e) to U.S. Provisional Patent Application Ser. No. 61/757,611 filed Jan. 28, 2013, which is incorporated herein by reference in its entirety.

### BACKGROUND

Unless otherwise indicated herein, the materials described in this section are not prior art to the claims in this application and are not admitted to be prior art by inclusion in this section.

For forensic analysis of data stored in a computing device, conventional forensic systems are configured to create or duplicate a drive image of all storage media of the computing device. A drive image is typically an exact replica of all contents of the storage media, such as a hard drive. The media duplication automatically processes every bit of any given piece of the storage media.

Some forensic approaches and technologies may be efficient for data analysis but they still require identification of copied data by examiners prior to conducting any forensic analysis. As known to one of ordinary skills in the art, there are no solutions that provide technologies or methodologies for specifically identifying prior to duplicating particular drives, folders, and files.

Therefore, there is a need for a system and method that mitigate these issues in acquiring targeted data stored in a computing device.

### SUMMARY

Disclosed herein are exemplary embodiments of a method and system for acquiring targeted data from a computing device using a programmed data acquiring apparatus.

In one aspect, an embodiment of a computer-implemented method for acquiring targeted data stored in a computing device using a data acquiring apparatus is provided. The method includes coupling the computing device to the data acquiring apparatus, determining that the data acquiring apparatus has been recognized by the computing device, and displaying a user interface on a screen associated with the computing device, wherein the user interface lists a plurality of data acquiring programs. The method further includes determining whether a user selected one of the plurality of data acquiring programs on the user interface, detecting a designation of a particular drive of the computing device following the user selection of the one of the plurality of data acquiring programs, activating the selected one of the plurality of data acquiring programs to search in the designated particular drive for a data entity that corresponds to a search function of the selected one of the plurality of data acquiring programs, generating a copy of the data entity if found by the search, and submitting the copied data entity to a folder in the data acquiring apparatus for further processing.

In another aspect, the method includes displaying a list of interfaces for collecting desirable notes about the computing device.

In yet another aspect, the method includes activating the selected one of the plurality of data acquiring programs to search for the data entity in all drives located in the computing device based on the determination that the user did not select one of the plurality of data acquiring programs.

In yet another aspect, a non-transitory computer-readable storage medium comprising programming instructions of the above mentioned method that are executable by a processor to acquire targeted data stored in a computing device using a data acquiring apparatus, the method comprising:

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the embodiments by way of example only and not by way of limitation.

### BRIEF DESCRIPTION OF THE FIGURES

In the figures:

FIG. 1 is a schematic diagram illustrating a data acquiring apparatus coupled to a computing device

FIG. 2 is a block diagram illustrating an exemplary embodiment of components of the a data acquiring apparatus configured for acquiring targeted data stored in a computing device;

FIG. 3 is a schematic diagram illustrating a variety of exemplary computing devices that can be coupled to the data acquisition apparatus;

FIG. 4 is a block diagram illustrating a contact information window displayed on a screen associated with the computing device;

FIG. 5 is a block diagram illustrating a main menu of the data acquisition application that lists a plurality of data acquiring programs and a plurality of user interfaces;

FIG. 6 is a block diagram illustrating a terms of use window displayed on the screen of the computing device;

FIG. 7 is a block diagram illustrating a user account control window displayed on the screen of the computing device;

FIG. 8 is a block diagram illustrating a message box indicating that the data acquiring application is ready to begin;

FIG. 9 is a block diagram illustrating a command prompt window that can list a number of copied bytes;

FIG. 10 is a block diagram illustrating a message box instructing the user to unplug the computing device when the data acquisition application has finished;

FIG. 11 is a flow chart illustrating programs configured to identify targeted drives, folders, and files for data duplication;

FIG. 12 is a block diagram illustrating an evidence intake interface;

FIG. 13 is a block diagram illustrating a chain of custody interface;

FIG. 14 is a block diagram illustrating an analyst's notes interface;

FIG. 15 is a block diagram illustrating a window that includes a field for entering drive characters for a capture email program;

FIG. 16 is a block diagram illustrating a window that includes a field for entering drive characters for a capture graphics program;

FIG. 17 is a block diagram illustrating a window that includes a field for entering drive characters for a capture financials program;

FIG. 18 is a block diagram illustrating a window that includes a field for entering search terms, drive characters, and extensions for a capture search terms program;

FIG. 19 is a block diagram illustrating a window that includes a field for entering keywords, drive characters, and extensions for a capture by file name program;

FIG. 20 is a flow chart of an exemplary method for acquiring targeted data from a computing device using a programmed data processing apparatus; and

FIG. 21 is a schematic diagram illustrating a conceptual partial view of an example computer program product.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### Overview

As known, digital data has inherent key differences as compared to traditional paper data. Because electronic data is easily created, duplicated and manipulated, there is generally a greater amount of computer data than paper data. Digital data can be far easier to organize, search, and stored or rejected based on searched info. As a result of the ease of creation, manipulation, duplication, and storage of digital media, many of the documents and files created today are stored only in computers. Computer data also contains unique electronic information not present in paper documents. Such information known as “metadata” can include user information, transmission and edit data, and various time stamps. Computer data is also electronically searchable and sortable by both the actual file contents and its metadata. A user can specifically target and manage relevant information through targeting searches.

Because of the complexity of the tools involved and knowledge required for conducting computer forensics, there is a need for a tool that enables a user to conduct electronic discovery. Thus, this needed tool should insure that proper precautions be taken during electronic discovery, and forensically sound procedures must be used to show that the recovered evidence is valid and reliable.

Moreover, authentication and chain of custody are also important considerations. In order for the gathered evidence to be useful in court, it is important that the data not be damaged Of compromised.

In accordance with an exemplary embodiment of the present disclosure, a data acquiring apparatus incorporates hardware and software components for comprehensive digital acquisition of data stored in a computing device. The hardware component may include memory unit, such as a 2.5 inch hard drive, is equipped with an universal serial bus (USB), such as current state of the art USB 3.0, and is encryptingly protected, such as with a 256-bit encryption. The software component loaded onto the memory unit incorporates a plurality of programs (i.e., applications) for acquiring a variety of data from a target computing device. In accordance to the present disclosure, the data acquiring programs may include a drive imaging program, an email capturing program, a graphics capturing program, a financial-data capturing program, a search-by-term capturing program, and a search-by-filename capturing program.

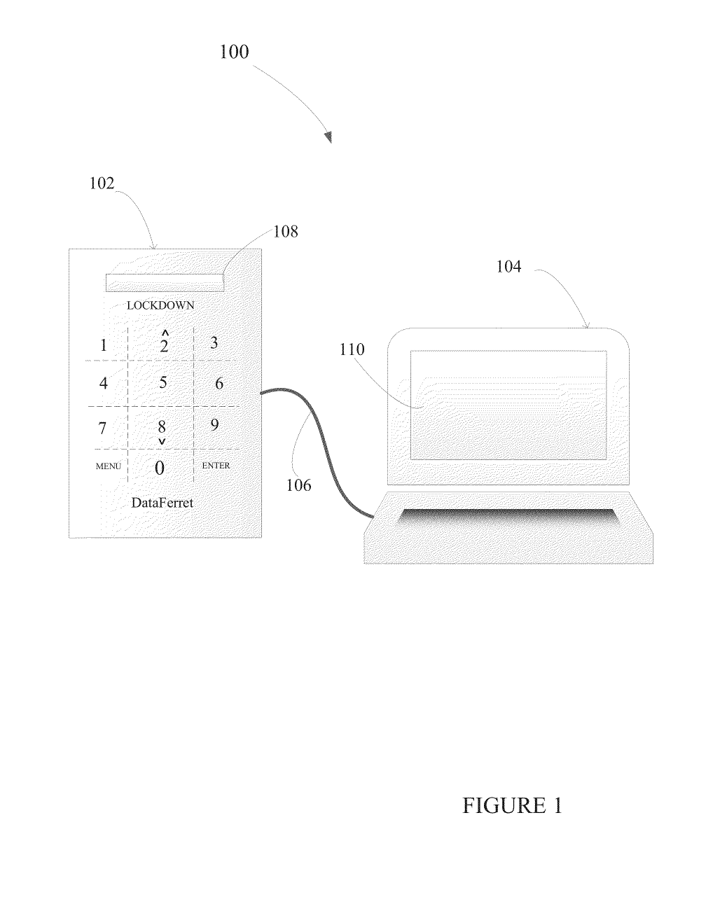

In accordance with an exemplary embodiment, in order to proceed with the acquisition of targeted data from a computing device, as shown in FIG. 1, a programmed data acquiring apparatus 102 is coupled to a computing device 104 via an USB power cable 106.

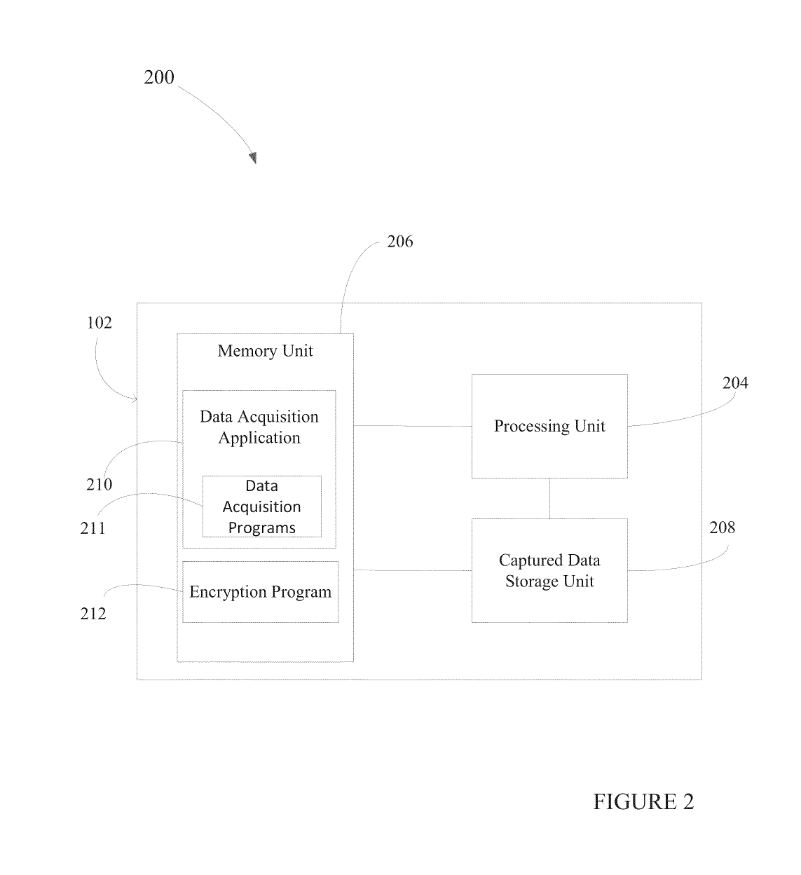

Referring to FIG. 2, a block diagram 200 illustrates an exemplary embodiment of data acquiring apparatus 102, including processing, storing, and software components. As shown, data acquiring apparatus 102 includes a processing unit 204 coupled to a memory unit 206 and to a captured data storage unit 108. Memory unit 206 includes a data acquisition application 210 that includes a plurality of acquisition programs 211, and an encryption program 212 for protecting data acquiring apparatus 102. Processor unit 204 is configured to execute instructions and to carry out operations associated components of memory unit 206. For example, using instructions retrieved from memory unit 206, processor unit 204 may control the identification and acquisition of data stored in computing device 104.

Processing unit 204 can be implemented on a single-chip, multiple chips or multiple electrical components. For example, various architectures can be used for processor unit 204, including dedicated or embedded processor or microprocessor (μP), single purpose processor, controller or a microcontroller (μC), application-specific integrated circuit (ASIC), reduced instruction set controller (RISC) processor, or any combination thereof, and so forth. In most cases, processor unit 204 together with an operating system operates to execute computer code and produce and use data.

Memory unit 206 generally provides a place to store computer code and data that are used by data acquiring apparatus 102. Memory unit 206 may include but not limited to non-volatile memory, such as read-only memory (ROM, flash memory, etc.), volatile memory, such as random-access memory (RAM), a hard disk drive and/or the like.

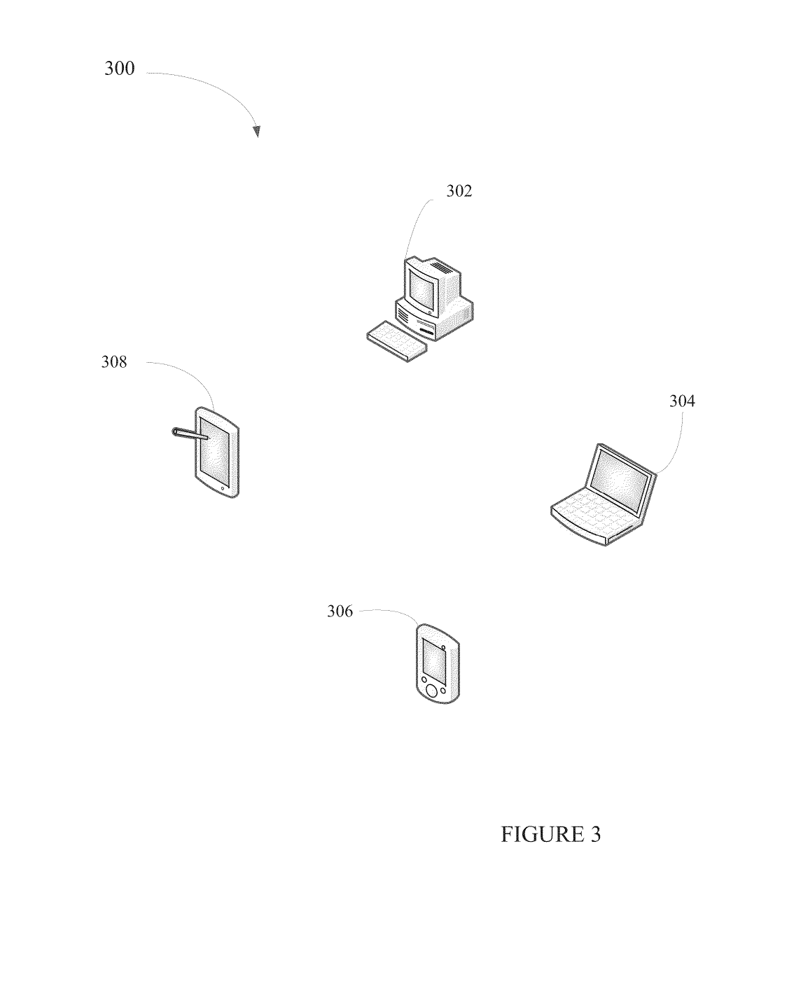

Now referring to FIG. 3, a plurality of embodiments of computing device 104 whose specific stored data may be targeted for duplication by data acquiring apparatus 102 are shown. As shown, the plurality of embodiments of computing device 104 includes a desktop unit 302, a laptop unit 304, a personal data assistant (PDA) 306, a tablet computer 308, or a hybrid device that includes any of the above functions.

Once coupled to data acquiring apparatus 102, a screen 110 of computing device 104 may indicate that there is a need to install some drivers for the new hardware that has been connected. Typically, drivers to be loaded are provided by Microsoft, are specific to the operating system of the computing device, and are for accessing USB devices. In accordance with the present disclosure, no drivers are provided for data acquiring apparatus 102. As such, the user may need to click on displayed “YES” or “OK” buttons, or on another appropriate response to let the computing device install and recognize data acquiring apparatus 102 as being attached to computing device 104.

Once data acquiring apparatus 102 is properly connected to computing device 104, which is turned on, a password input menu 108 lights up on a front side of the data acquiring apparatus, near a top end of the front side. When a user is provided this particular data acquiring apparatus 102, he/she is also provided a password to be entered in password input menu 108, when requested.

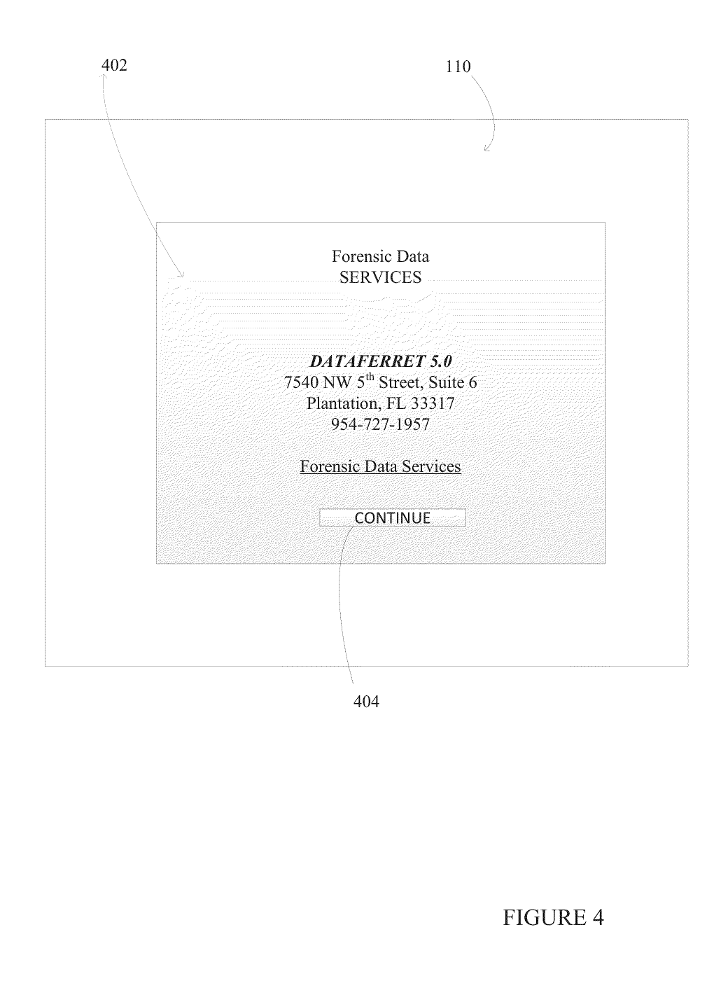

Once data acquiring apparatus 102 is recognized, computing device 104 generates and displays a window, such as an AutoPlay Window, to allow the user to open a Window's File Menu. As known to one of one of ordinary skills in the art, all Windows Operating Systems provide a Window Explorer File Viewer, which when opened can display a list of files and applications (programs) that can be opened and/or activated by a click by the user. In accordance with the present disclosure, an application tilted “DataFerret” will be listed, and once selected by the user, will trigger a generation and display, on screen 110, of a user interface screen that includes a contact information window 402, shown in FIG. 4.

As shown in FIG. 4, contact information window 402 displays the name of the business (i.e., “Forensic Data Services”), the name of the data acquiring application (i.e., “DATAFERRET 5.0”), the address and contact phone number of the business, and a Uniform Resource Locator (URL) link to the business (i.e., “forensic data services”). Moreover, contact information window 402 includes a key called “Continue” 404 for triggering the process of acquiring desired data, such as copies of particular files and folders and images of specific drives.

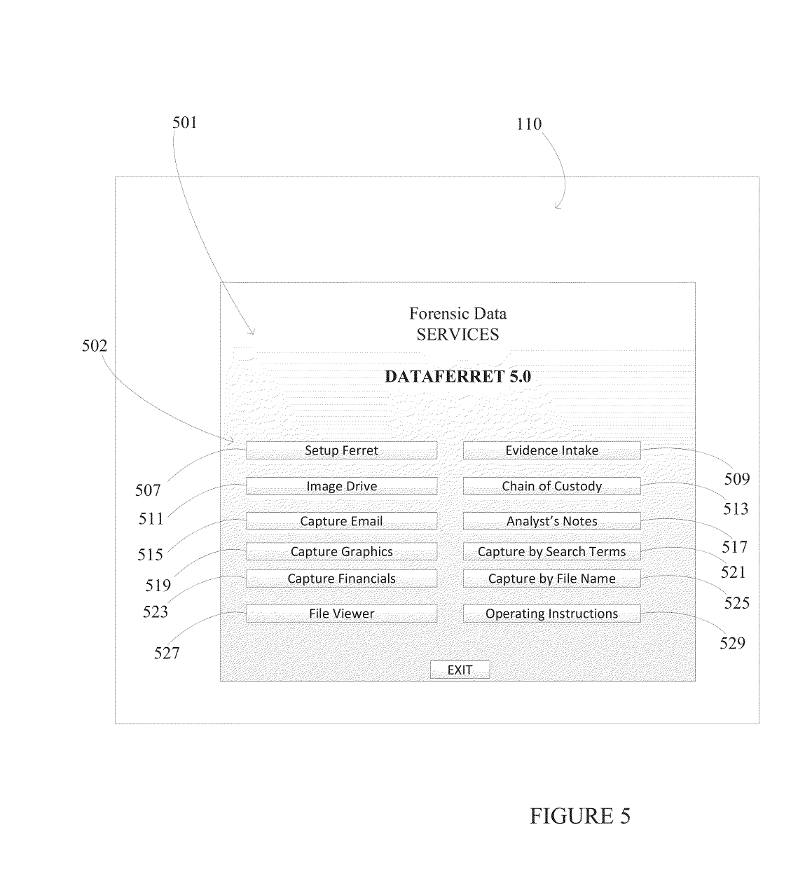

In one embodiment, following a click on Continue key 404, the process of acquiring desired data, which is performed by a processor integral to data acquiring apparatus 102, is configured to generate and display on screen 110, shown in FIG. 5, a user interface screen 501 that includes a main menu 502 of the data acquiring application. As shown, main menu 502 includes a list of buttons, each of which is associated with a particular application that can be activated by a user selection of the associated button. In one embodiment, the list of buttons includes a “Setup Ferret” button 507, an “Evidence Intake” button 509, an “Image Drive” button 511, a “Chain of Custody” button 513, a “Capture Email” button 515, an “Analyst's Notes” button 517, a “Capture Graphics” button 519, a “Capture by Search Terms” button 521, a “Capture Financials” button 523, a “Capture by File Name” button 525, a “File Viewer” button 527, and an “Operating Instructions” button 529.

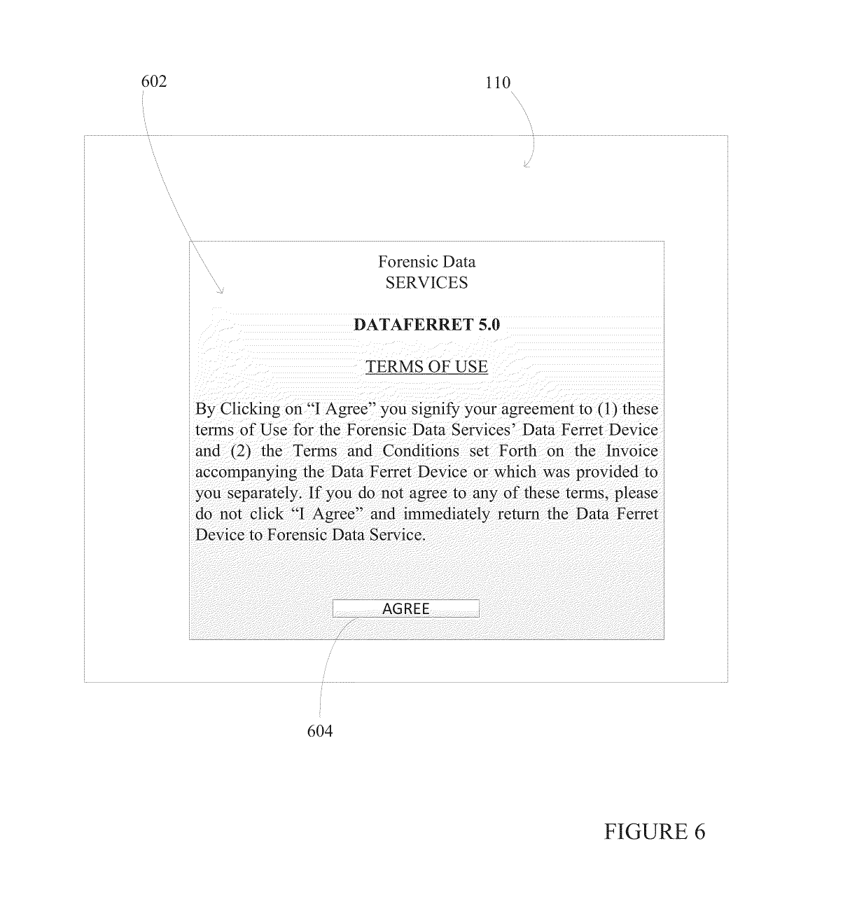

Alternatively, following the selection of Continue key 404, as shown in FIG. 6, a “Terms and Conditions” window is generated and displayed on screen 110. Window 602 may include a “Terms of Use” text that the user is advised to review, and an “Agree” button 604 that the user can select if he/she wishes to activate the data acquiring application. Once, the “Agree” button 604 is selected the above discussed main menu 502 is displayed.

Upon selection of the “Setup Ferret” button 507, a Message box is generated and displayed to inform the user that the data acquiring application is activated and ready for data capture. By clicking on an “OK” button shown on a message box that indicates that the data acquiring application is ready to capture data, the process triggers a display of main menu 502. Accordingly, if the user is interested in having an image of a drive of computing device 104 captured, he/she can select “Image Drive” button 511. Moreover, in order to capture copies (i.e. images) of additional drives, the user can repeat the above-discussed steps for each additional drive.

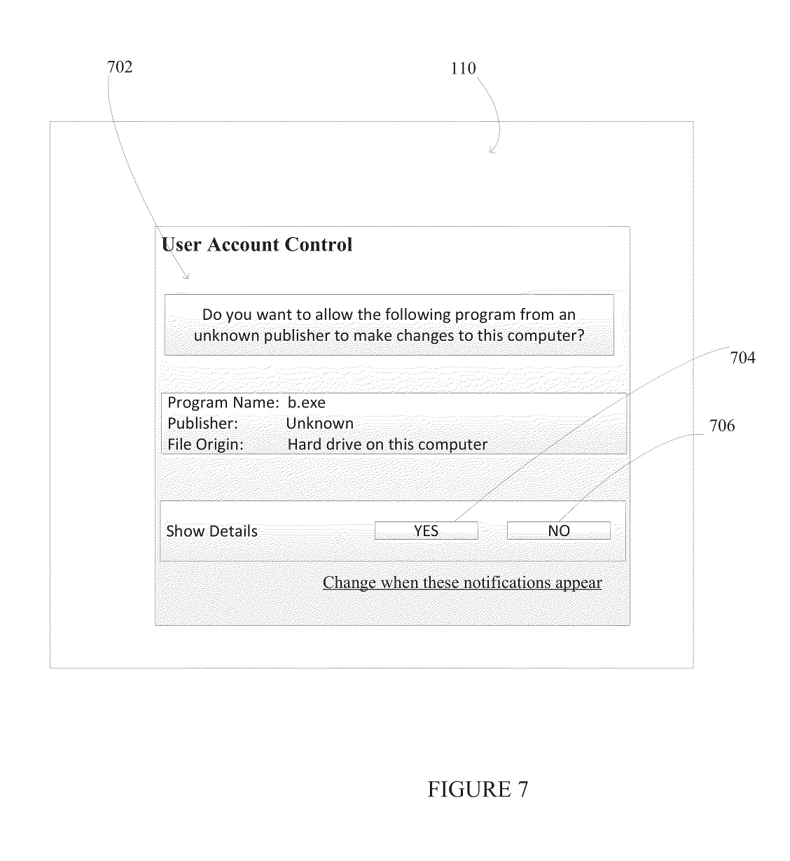

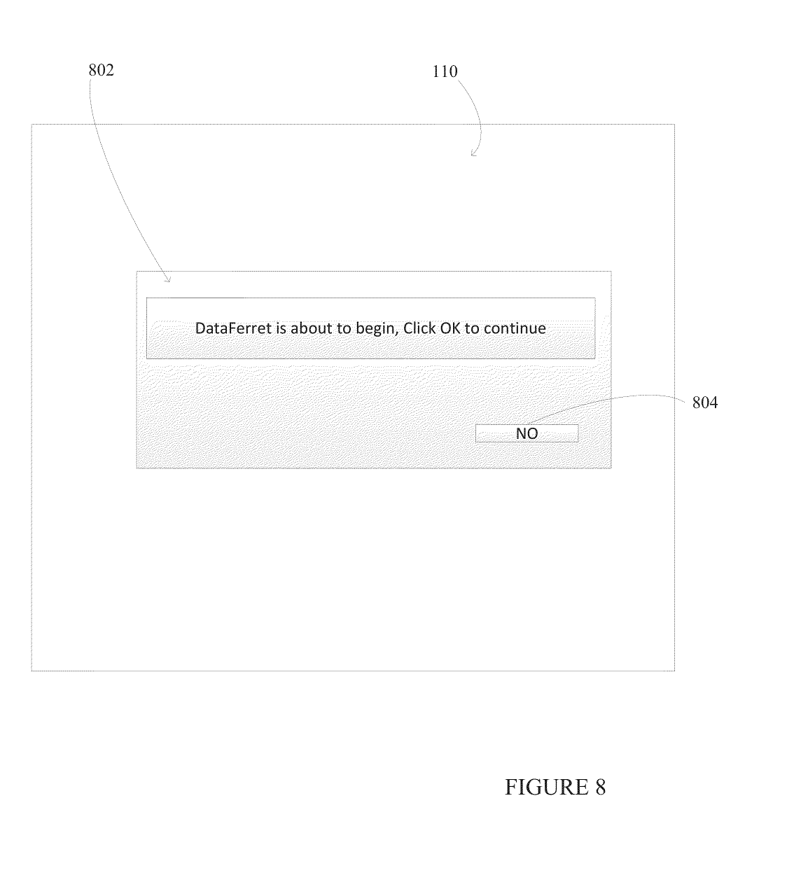

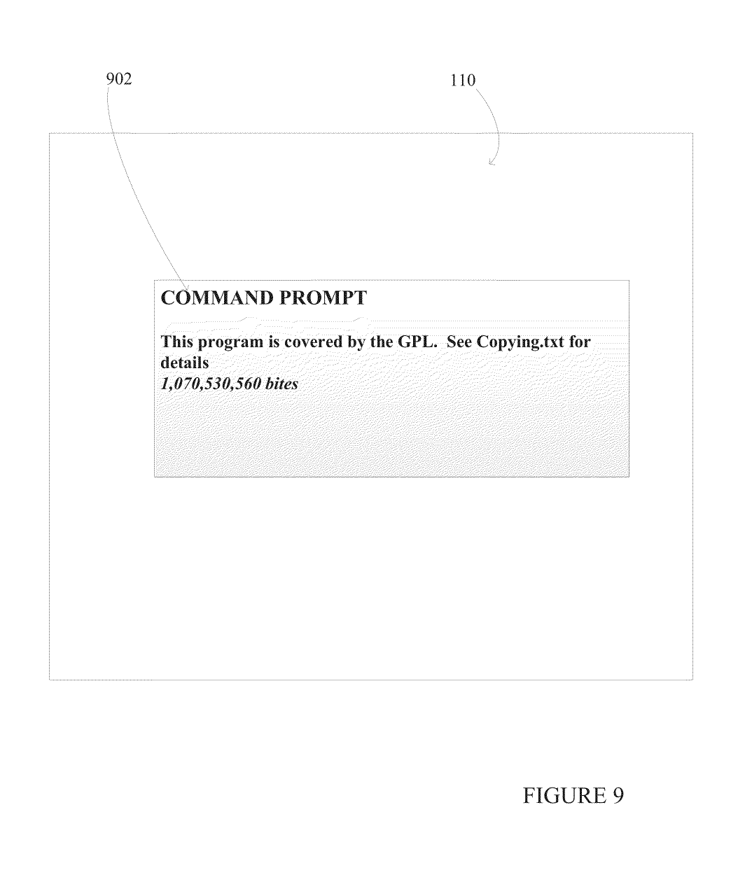

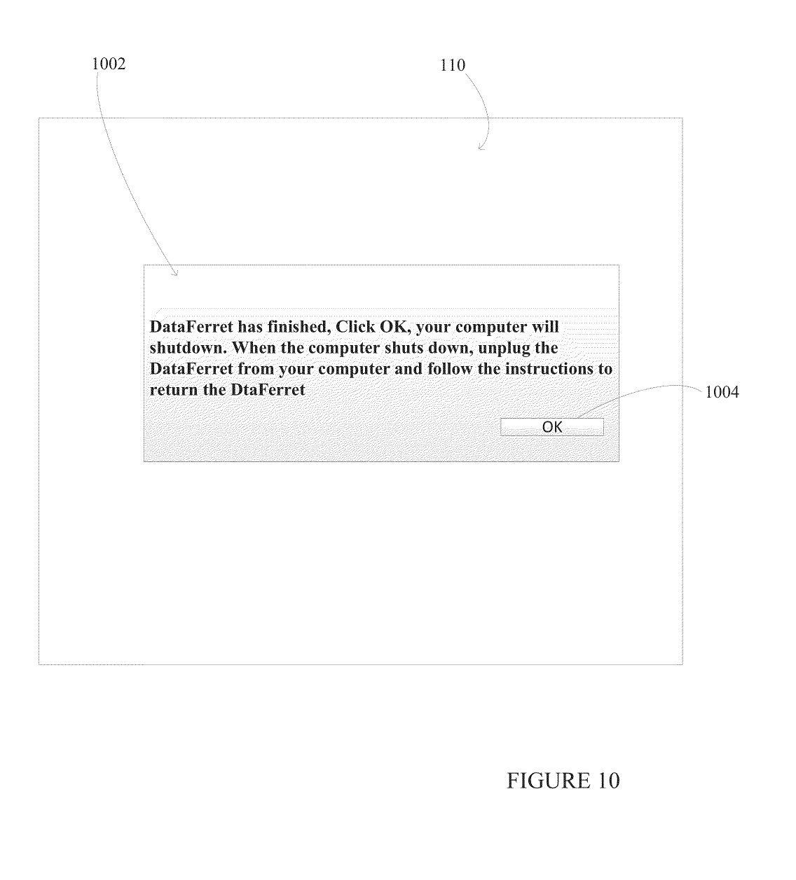

In one embodiment, for advanced use beyond the above described do-it-yourself functions, in lieu of clicking on “Setup Ferret” button 507, the user may click on the “Operating Instructions” button 529. This alternate clicking triggers an opening of a “User Account Control” window 702, shown in FIG. 7. This window 702 includes a request that ask whether the user is willing to allow a program, whose name is displayed below the request, provided by an unknown publisher to make changes to computing device 104. In response to a clicking by the user on a “Yes” button 704, another message box 802, shown in FIG. 8, is displayed on screen 110 to indicate that the data acquiring application is ready to begin, and that the use can click on a displayed “OK” button 804 to continue. Following the clicking on the “OK” button 804, the data acquiring application 201 proceeds with the acquisition of data stored in drives of computing device 104. Once the data acquisition is performed, data acquiring application 201 is configured to generate and display on screen 110 a “Command Prompt” window 902, shown in FIG. 9, that lists a number of bytes copied. As known to one of ordinary skills in the art, the length of time needed to capture the copied data is dependent upon the amount of bytes collected. At the conclusion of the image capture, another message box 1002, shown in FIG. 10, is generated and displayed on screen 110 indicating that data acquiring apparatus 102 is finished collecting data. Message box 1002 further indicates that by clicking on an “OK” button 1004, computing device 104 will shut down, and the user is asked to uncouple data acquiring apparatus 102 from computing device 104 and follow instructions to return data acquiring apparatus 102 for the analysis of the captured data.

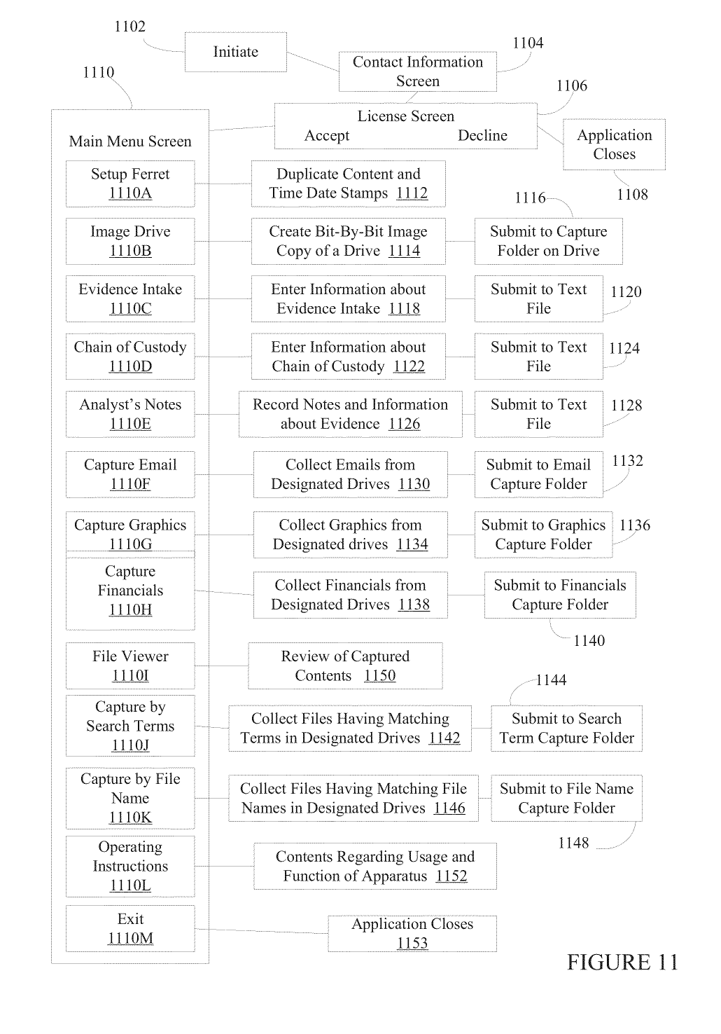

Now referring to FIG. 11, a flow chart 1100 illustrates an exemplary embodiment of the above-discussed data acquisition application 201 and the above-introduced variety of programs configured to identify drives, folders, and files of computing device 104 for data duplication. As stated-above, upon coupling of data acquiring apparatus 102 to a computing device 104, the user is provided a requested in a contact information screen to enter a password. Still referring to FIG. 11, once initiated at Step 1102, and following entry of contact info into a contact information screen, at Step 1104, data acquiring application 201 is configured to generate a license screen, at Step 1106, which lists an “Accept” button and a “Decline” button for selection by the user. In case, the user selects the “Decline” button, then data acquiring application 201 is configured to terminate the process and close down, at Step 1108. Otherwise, if the user selects the “Accept” button, then data acquiring application 201 is configured to generate and display the above-discussed user interface 501 that includes main menu 502, at Step 1110. As stated-above, main menu 502 includes a plurality of buttons, each of which is configured to trigger a corresponding program when selected by the user. The Plurality of programs includes a “Setup Ferret” program 1110A, an “Evidence Intake” program 1110B, an “Image Drive” program 1110C, a “Chain of Custody” program 1110D, a “Capture Email” program 1110E, an “Analyst's Notes” program 1110F, a “Capture Graphics” program 1110G, a “Capture by Search Terms” program 1110H, a “Capture Financials” program 1110I, a “Capture by File Name” program 1110J, a “File Viewer” program 1110K, and an “Operating Instructions” program 1110L.

Upon selection of the “Setup Ferret” button 507, the associated “Setup Ferret” program 1110A is configured to duplicate contents and time date stamps, and creates new folders called “Image Capture” on a hard drive of data acquiring apparatus 102 for storing the new captured data, at Step 1112.

Upon selection of the “Image Drive” button 511, the associated “Image Drive” program 1110C is configured to create a forensically sound bit-by-bit image copy of a targeted device drive, such as a primary hard drive, at Step 1114. Subsequently, the created image copy is submitted to a capture folder on data acquiring apparatus 102, at Step 1116. Additionally, the “Image Drive” program can be further configured to save start and end times of the data duplication (i.e., imaging).

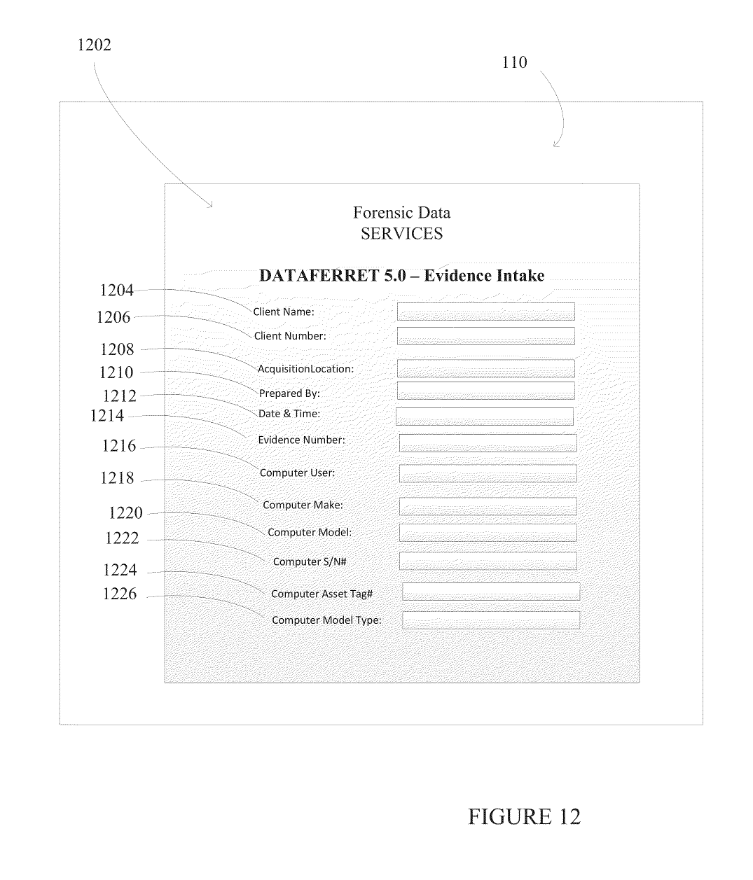

Upon selection of the “Evidence Intake” button 509, the associated “Evidence Intake” program 1110B is configured to generate and display a user interface screen that includes an “Evidence Intake” window 1202, shown in FIG. 12, which allows the user to enter information, on-site, about the evidence intake, at Step 1118. As shown in FIG. 12, window 1202 includes a number of data entry fields, which include a “Client Name” field 1204, a “Client Number” field 1206, an “Acquisition Location” field 1208, a “Prepared By” field 1210, a “Date & Time” field 1212, an “Evidence Number” field 1214, a “Computer User” field 1216, a “Computer Make” field 1218, a “Computer Model” field 1220, a “Computer S/N #” field 1222, a “Computer Asset Tag #” field 1224, and a “Computer Model Type” field 1226. Window 1202 further includes form buttons, such as “Back” button, a “Submit” button, a “Reset” button, and an “Edit” button. As such, once the user has filled in the fields 1204-1228 with appropriate information, he/she may click on the “Back” button to go back to the main menu, may click on the “Reset” button to clear all of the information entered in the fields 1204-1226, may click on the “Edit” button to edit some or all of the entered information, and may click on the “Submit” button to submit the entered information that he/she is satisfied with. Upon submission of the entered information, the “Evidence Intake” program is configured to submit the entered information to a text file, and generate and display a message box that indicates that the entered information has been submitted, at Step 1120. Moreover, the “Evidence Intake” program 1110B is configured to generate a notepad to display the submitted information. As such, this “Evidence Intake” user interface allows the user to easily save information important to the legal process by which evidence is acquired.

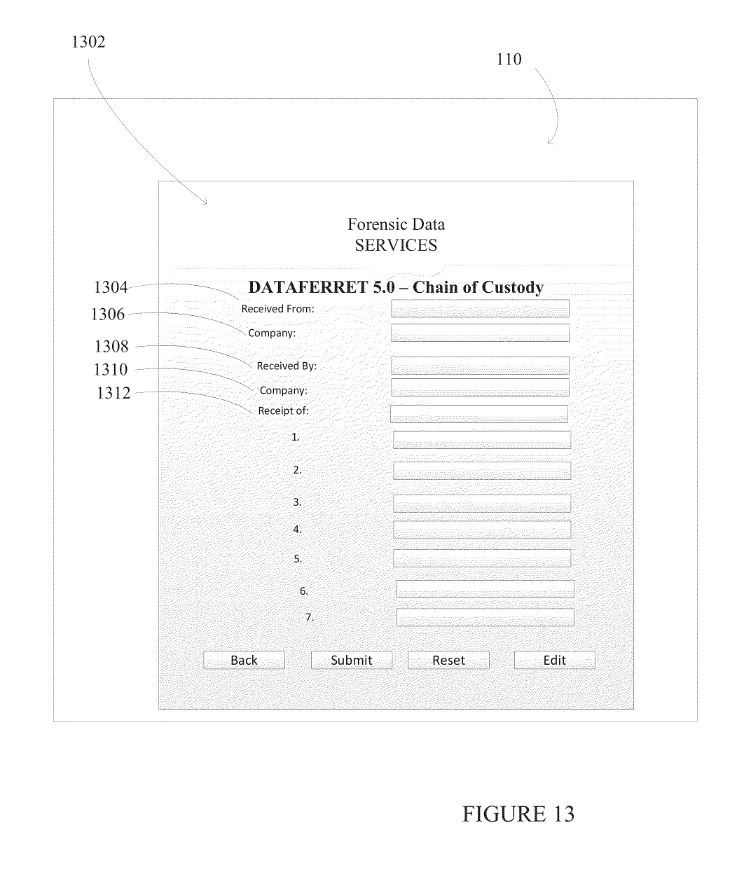

Upon selection of the “Chain of Custody” button 513, the associated “Chain of Custody” program 1110D is configured to generate and display a user interface screen that includes a “Chain of Custody” window 1302, shown in FIG. 13, which allows the user to record information into data acquiring apparatus 102 about the Chain of Custody of the evidence, at Step 1122. As shown in FIG. 13, window 1302 includes a number of data entry fields, which include a “Received From” field 1304, a “Company” field 1306, a “Received By” field 1308, another “Company” field 1310, and a number of “Receipt of fields 1312. Window 1302 further includes form buttons, such as “Back” button, a “Submit” button, a “Reset” button, and an “Edit” button. As such, once the user has filled in the fields 1304-1312 with appropriate information, he/she may click on the “Back” button to go back to the main menu, may click on the “Reset” button to clear all of the information entered in the fields 1304-1312, may click on the “Edit” button to edit some or all of the entered information, and may click on the “Submit” button to submit the entered information that he/she is satisfied with. Upon submission of the entered information, the “Chain of Custody” program is configured to submit the entered information to a text file, and generate and display a message box that indicates that the entered information has been submitted, at Step 1124. Moreover, the “Chain of Custody” program is configured to generate a notepad to display the submitted information. As such, the “Chain of Custody” user interface allows the user to easily save information important to the legal process of maintaining a chain of custody of the evidence.

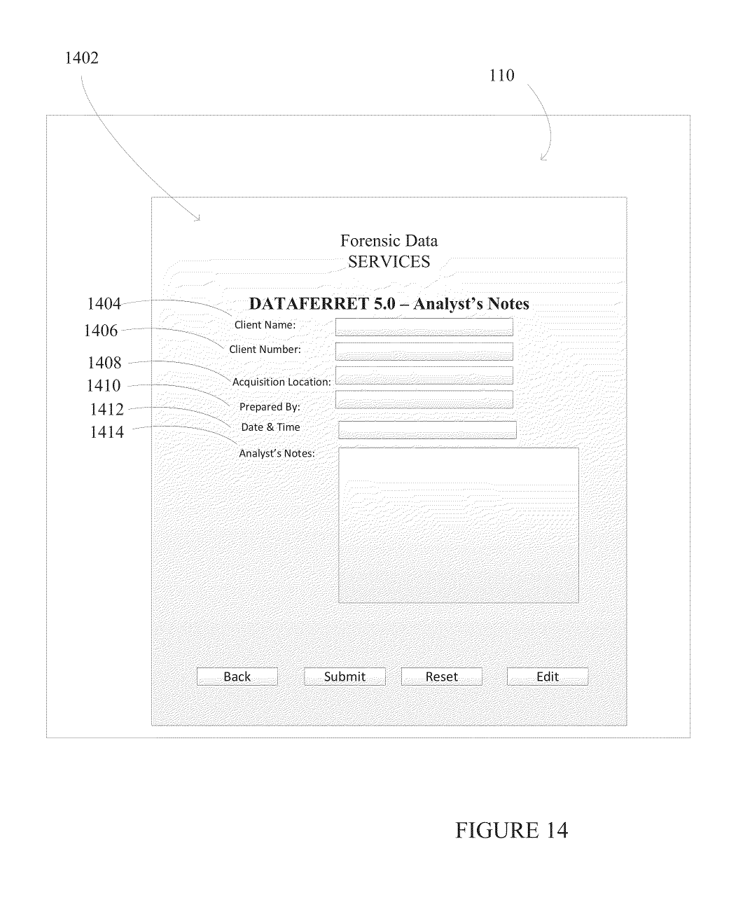

Upon selection of the “Analyst's Notes” button 517, the associated “Analyst's Notes” program 1110F is configured to generate and display a user interface screen that includes a “Analyst's Notes” window 1402, shown in FIG. 14, which allows the user to record notes and information into data acquiring apparatus 102 about the evidence, at Step 1126. As shown in FIG. 14, window 1402 includes a number of data entry fields, which include a “Client Name” field 1404, a “Client Number” field 1406, an “Acquisition Location” field 1408, a “Prepared By” field 1410, a “Date & Time” field 1412, and a “Analyst's Notes” field 1414. Window 1402 further includes form buttons, such as “Back” button, a “Submit” button, a “Reset” button, and an “Edit” button. As such, once the user has filled in the fields 1404-1414 with appropriate information, he/she may click on the “Back” button to go back to the main menu, may click on the “Reset” button to clear all of the information entered in the fields 1404-1414, may click on the “Edit” button to edit some or all of the entered information, and may click on the “Submit” button to submit the entered information that he/she is satisfied with. Upon submission of the entered information, the “Analyst's Notes” program is configured to submit the entered information to a text file, and generate and display a message box that indicates that the entered information has been submitted, at Step 1128. Moreover, the “Analyst's Notes” program is configured to generate a notepad to display the submitted information. As such, this “Analyst Notes” user interface allows the user to easily save any other information important to the manner in which data is acquired.

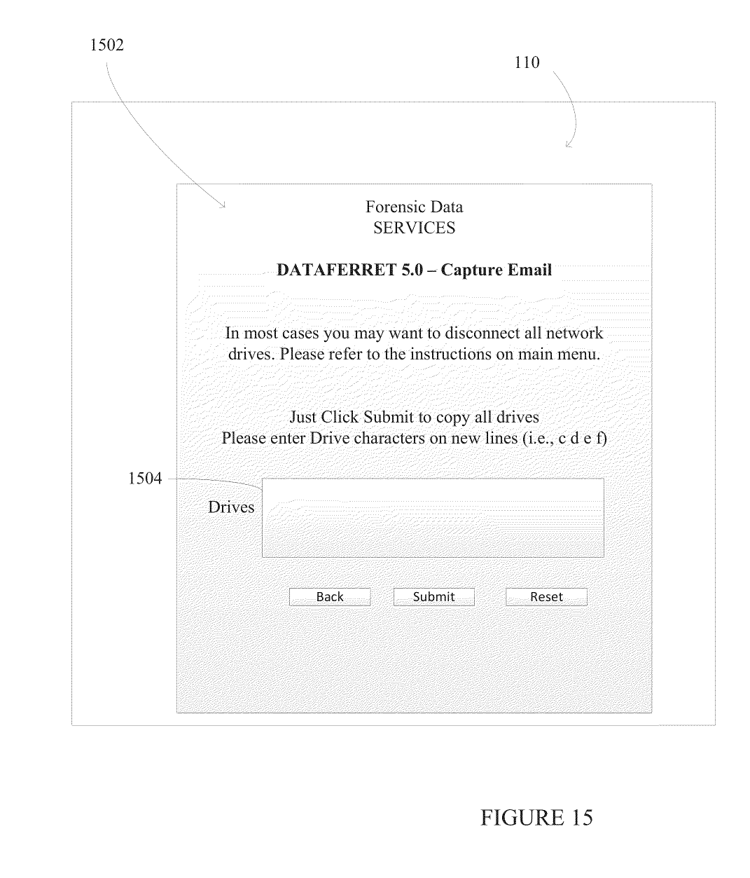

Upon selection of the “Capture Email” button 515, the associated “Capture Email” program 1110E is configured to begin collecting the emails from the designated drives based on file extension, and generate and display a user interface screen that includes a “Capture Email” window 1502, shown in FIG. 15, which allows the user to enter the name of the designated drives in field 1504, at Step 1130. As shown in FIG. 15, window 1302 includes instructions to the user, such as “In most cases, you may want to disconnect all network drives. Please refer to the instructions on the main menu,” “Just click submit to copy all drives,” and “Please enter Drive Characters on new lines (i.e., c, d, e, f).” Thus, the “Capture Email” program is configured to search designated drives of computing device 104 for email files and files relating to email applications. The “Capture Email” program further creates a list of the discovered files and attempts to copy them to a capture folder called “Email” of acquiring apparatus 102 for further processing, at Step 1132. If no target drives are specified, the “Capture Email” program searches all drives. Further, errors detected during the copying process are recorded.

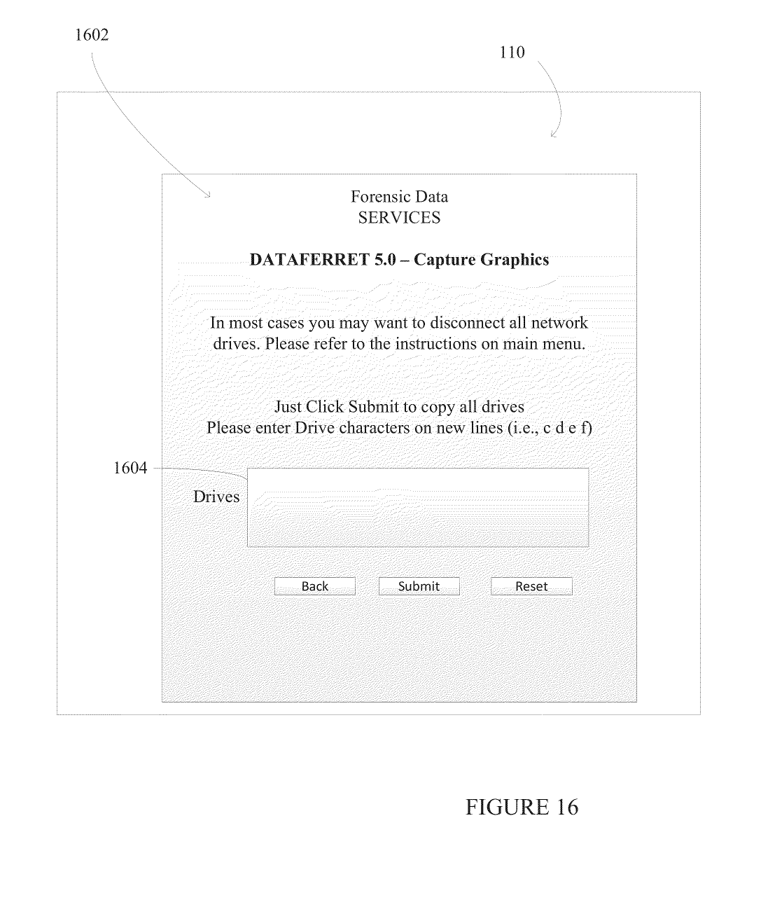

Upon selection of the “Capture Graphics” button 519, the associated “Capture Graphics” program 1110G is configured to search and collect from designated drives of computing device 104 graphics files and files relating to graphics applications based on file extension, and generate and display a user interface screen that includes a “Capture Graphics” window 1602, shown in FIG. 16, which allows the user to enter the name of the designated drives in field 1604, at Step 1134. As shown in FIG. 16, window 1602 includes similar instructions as those of window 1502. The “Capture Graphics” program further creates a list of the discovered files and attempts to copy them to a capture folder called “Capture Graphics” of acquiring apparatus 102 for further processing, at Step 1136. Moreover, if no designated drives are specified, the “Capture Graphics” program searches all drives. Further, errors detected during the copying process are recorded.

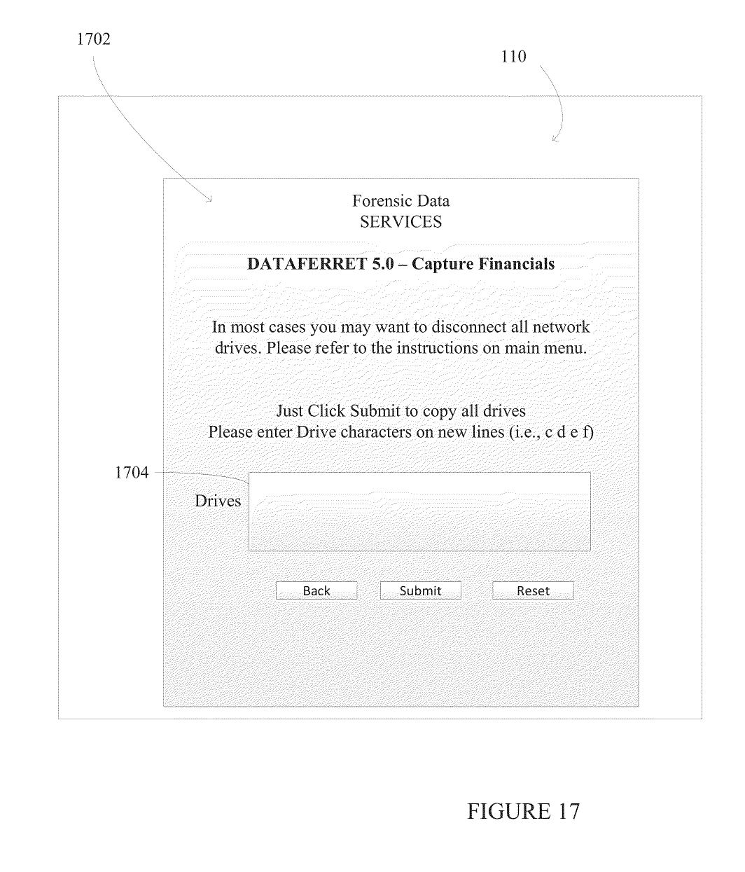

Upon selection of the “Capture Financials” button 523, the associated “Capture Financials” program 1110I is configured to search and collect from designated drives of computing device 104 financial files and files relating to financial applications based on file extension, and generate and display a user interface screen that includes a “Capture Financials” window 1702, shown in FIG. 17, which allows the user to enter the name of the designated drives in field 1704, at Step 1138. As shown in FIG. 17, window 1702 includes similar instructions as those of window 1502. The “Capture Financials” program further creates a list of the discovered files and attempts to copy them to a capture folder called “Capture Financials” of acquiring apparatus 102 for further processing, at Step 1140. Moreover, if no designated drives are specified, the “Capture Financials” program searches all drives. Further, errors detected during the copying process are recorded.

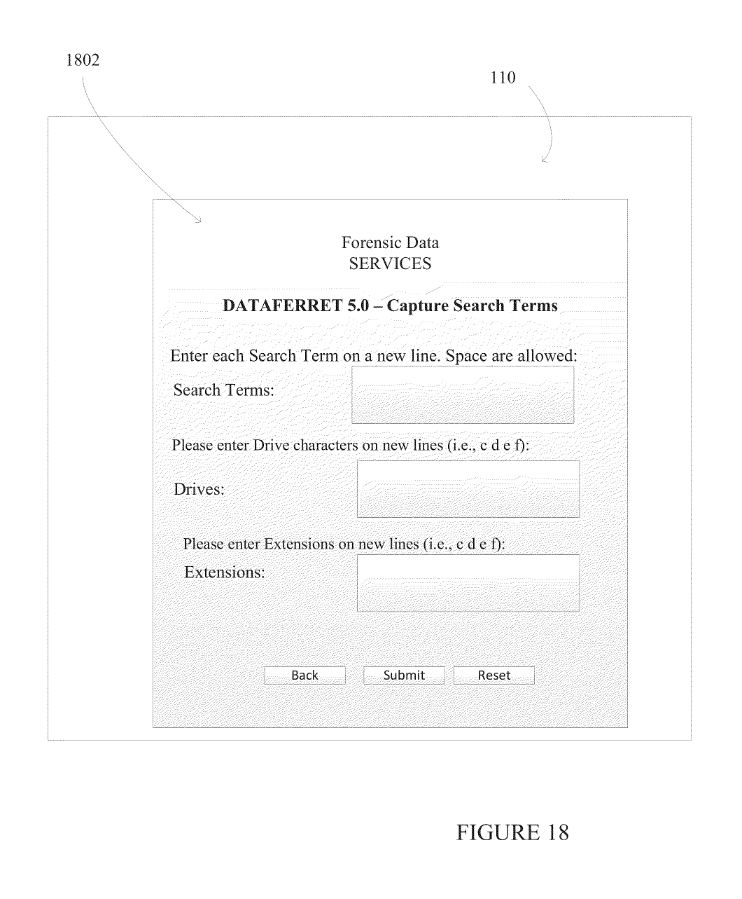

Upon selection of the “Capture by Search Terms” button 521, the associated “Capture by Search Terms” program 1110H is configured to take an input of a list of search terms, a list of names of drives, and a list of file extensions, to search and collect files from designated drives of computing device 104 containing matching terms and extensions, and to create a directory of all files matching the selected extensions, at Step 1142. The “Capture by Search Terms” program is further configured to generate and display a user interface screen that includes a “Capture by Search Terms” window 1802, shown in FIG. 18, which includes instructions to the user, such as “Enter each search term on a new line,” “Please enter new drive characters on new lines,” and “Please enter extensions on new lines (i.e., doc, pdf, and text).” The “Capture by Search Terms” program is configured to search the contents of files, and attempt to match the chosen search terms with all ASCII strings encoded within the documents. Files that contain text matching the chosen search terms are copied to a Search Term folder in Capture folder located in data acquiring apparatus 102 for further processing, at Step 1144. The files are organized by which Search Term produced that file. If no target drives are specified, the program searches all drives. If no Search Terms were chosen, the program will not copy any files. If no target extensions are specified, the program searches for a list of predefined ASCII encoded or partially ASCII encoded file types. Further, errors detected during the copying process are recorded.

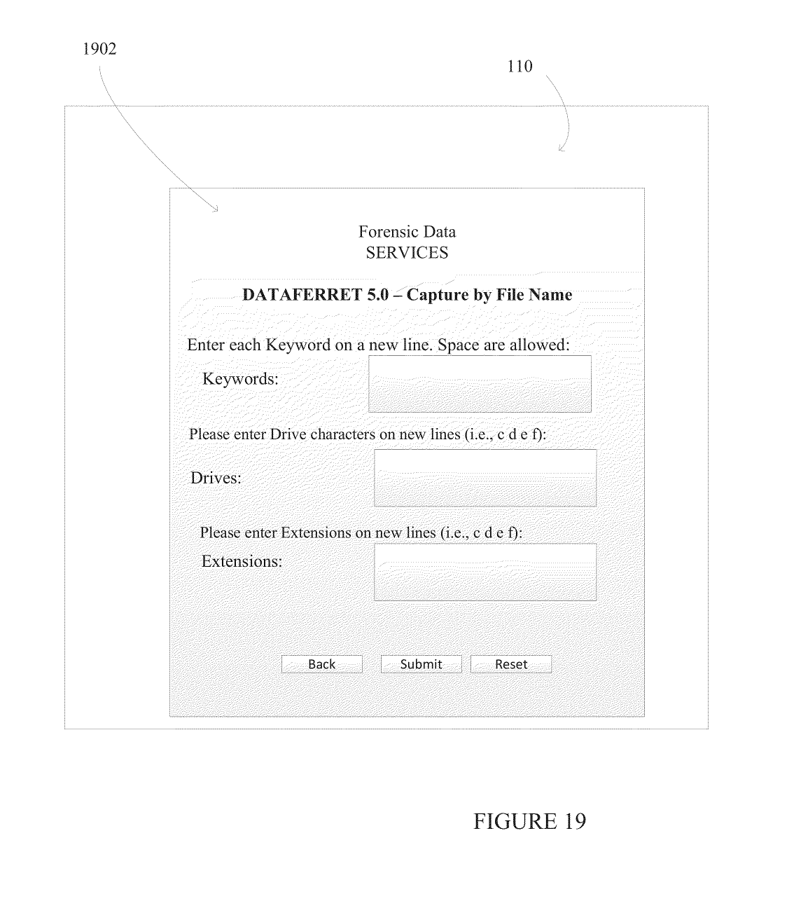

Upon selection of the “Capture by File Name” button 525, the associated “Capture by File Name” program 1110) is configured to take an input of a list of keywords, a list of drives, and a list of file extensions. The “Capture by File Name” program is configured to search designated drives and to create a directory of all files matching the chosen file names and extensions, at Step 1146. The “Capture by File Name” program is further configured to generate and display a user interface screen that includes a “Capture by File Name” window 1902, shown in FIG. 19, which includes instructions to the user, such as those displayed in window 1802. This “Capture by File Name” program is further configured to search the full filepath of these files, attempting to match the chosen keywords to any part of the filepath. Files whose filepath or filename contains the chosen keywords are copied to a Filename folder in Capture folder located data acquiring apparatus 102 for further processing, at Step 1148. The files are organized by which keywords produced that file. If no keywords were chosen, the program copies all files containing the chosen file extensions. If no target drives are designated, this program is configured to search all drives. If no target extensions are specified, the program includes all file types. If neither a list of keywords nor a list of extensions were chosen, the program will not copy any files. Further, errors detected during the copying process are recorded.

Upon selection of the “File Viewer” button 525, the associated “File Viewer” program 1110K is configured to generate and display a file window, such as “Windows Explorer”, that lists the captured contents and enables the user to preview the captured contents, at Step 1150.

Upon selection of the “Operating Instructions” button 529, as discussed above the associated “ Operating Instructions” program 1110L is configured to trigger an opening of the “User Account Control” window 702 that provides contents regarding usage and functions of data acquiring apparatus 102, at Step 1152.

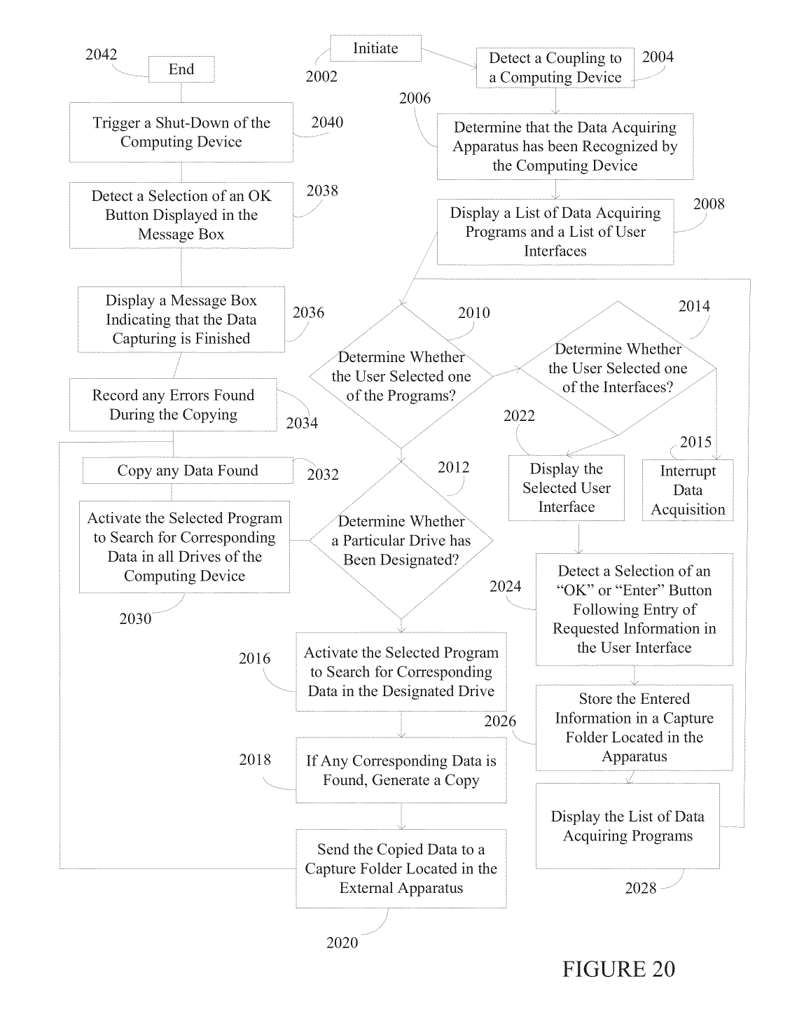

Now referring to FIG. 20, a flow chart 2000 illustrates an exemplary embodiment of a method, initiated at Step 2002, for acquiring targeted data stored in computing device 104. Upon coupling data acquiring apparatus 102 to computing device 104 by the user, data acquisition application is configured to detect the coupling, at Step 2004, and determine that data acquiring apparatus 102 has been recognized by computing device 104, at Step 2006. Subsequently, data acquisition application 201 is configured to display a list of data acquiring programs and a list of user interfaces, at Step 2008. Then at Step 2010, acquisition application 201 is configured to determine whether the user has selected one of the programs. In the affirmative, acquisition application 201 is configured to determine whether a particular drive has been designated by the user, at Step 2012. Otherwise, data acquisition application 201 is configured to determine whether the user has selected one of the user interfaces, at Step 2014.

Upon determination that a particular drive has been designated, acquisition application 201 is configured to activate the selected program to search for corresponding data in the designated drive, at Step 2016. In any corresponding data has been found, then a copy is generated, at Step 2018, and the copied data is send to a capture folder located in data acquiring apparatus 102, at Step 2020.

Upon determination that the user has selected a user interface, acquisition application 201 is configured to display the selected interface, at Step 2022. Following entry of information requested by the user interface, and detection of a selection of an “OK” or “Enter” button displayed on the user interface, at Step 2024, acquisition application 201 is configured to store the entered information in a capture folder located in data acquiring apparatus 102, at Step 2026. Subsequently, at Step 2028, acquisition application 201 is configured to display again the list of data acquiring programs to provide the user a second chance to select one of the data acquiring programs as provided at Step 2012. Upon determination that the user has not selected a user interface, acquisition application 201 is configured to interrupt data acquisition, at Step 2015.

Upon determination that the user has not designated a particular drive, data acquisition application 201 is configured to activate the selected program to search for corresponding data in all of the drives of computing device 104, at Step 2030, then copy any found data to a capture folder, at Step 2032. During the copying of the found data, data acquisition application 201 is configured to record any error that may be found during the copying, at Step 2034. Subsequently, data acquisition application 201 generates and displays a message box that indicates that the data capturing was finished, at Step 2036. The displayed message box includes an “OK” button. Upon detection of a selection of this “OK” button, at Step 2038, data acquisition application 201 is configured to trigger a shut-down of computing device 104.

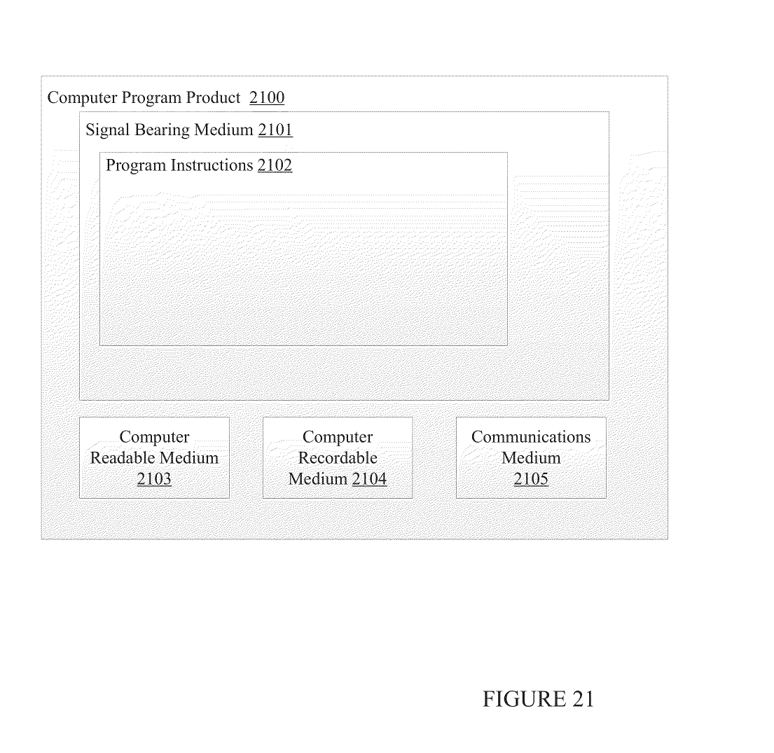

As discussed above, the disclosed methods are implemented as computer program instructions encoded on a computer-readable storage media in a machine-readable format. FIG. 21 is a schematic diagram illustrating a conceptual partial view of an example computer program product 2100 that includes a computer program for executing a computer process on a computing device, arranged according to at least some embodiments presented herein. In one embodiment, the example computer program product 2100 is provided using a signal bearing medium 2101. The signal bearing medium 2101 may include one or more programming instructions 2102 that, when executed by a processing unit may provide functionality or portions of the functionality described above with respect to the above described Figures. Thus, for example, referring to the embodiment shown in FIG. 20, one or more features of blocks 2004-2040, may be undertaken by one or more instructions associated with the signal bearing medium 2101.

In some examples, signal bearing medium 2101 may encompass a non-transitory computer-readable medium 2103, such as, but not limited to, a memory. In some implementations, the signal bearing medium 2101 may encompass a computer recordable medium 2104, such as, but not limited to, memory. In some implementations, signal bearing medium 2101 may encompass a communications medium 2105.

In one exemplary embodiment, the above-discussed programs are configured to utilize the Windows Command Prompt and are built upon powerful disk operating system (DOS) commands present in the Windows operating system. By stringing together the inputs and outputs of the many available DOS commands in singular batch files, these programs perform the above specified functions in relatively quick, automatic, and user compliant manners. The programs also attempt to use the newest file transfer utilities available to them depending on the version of Windows of the target computer.

The above-discussed programs, associated with the data acquisition application, are integrated through a single graphical user interface (GUI), which allows for the easy and straightforward utilization of these programs. The above-discussed three user interfaces are provided for easily storing important notes about computing device 104 (i.e., the target computer).

As discussed, all captured information is recorded in newly created files within external data acquiring apparatus 102. Moreover, by combining the above-discussed programs, applications, and hardware platform, external data acquiring apparatus 102 is a comprehensive tool for the targeted acquisition of data from computer systems in all manner of personal, professional, and legal circumstance.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. A computer-implemented method for acquiring targeted data stored in a computing device using a data acquiring apparatus, comprising:
coupling the computing device to the data acquiring apparatus;
determining that the data acquiring apparatus has been recognized by the computing device;
displaying a user interface on a screen associated with the computing device, wherein the user interface lists a plurality of data acquiring programs;
determining whether a user selected one of the plurality of data acquiring programs on the user interface;
detecting a designation of a particular drive of the computing device following the user selection of the one of the plurality of data acquiring programs;
activating the selected one of the plurality of data acquiring programs to search in the designated particular drive for a data entity that corresponds to a search function of the selected one of the plurality of data acquiring programs;
generating a copy of the data entity if found by the search; and
submitting the copied data entity to a folder in the data acquiring apparatus for further processing.

2. The computer-implemented method of claim 1, further comprising:
displaying a list of interfaces for collecting desirable notes about the computing device.

3. The computer-implemented method of claim 1, further comprising:
activating the selected one of the plurality of data acquiring programs to search for the data entity in all drives located in the computing device based on the determination that the user did not select one of the plurality of data acquiring programs.

4. The computer-implemented method of claim 1, further comprising:
recording any errors found during the generation of the copy of the found data entity.

5. The computer-implemented method of claim 1, wherein the plurality of data acquiring programs include an image drive program for generating an image of a hard drive of the computing device.

6. The computer-implemented method of claim 1, wherein the plurality of data acquiring programs include a capture email program for searching for e-mail files and files relating to e-mail applications.

7. The computer-implemented method of claim 1, wherein the plurality of data acquiring programs include a capture graphics program for searching for graphic files and files relating to graphics applications.

8. The computer-implemented method of claim 1, wherein the plurality of data acquiring programs includes a capture financials program for searching for files relating to finance applications

9. The computer-implemented method of claim 1, wherein the plurality of data acquiring programs includes a capture by search terms program for searching in the particular drive for files containing text matching chosen search terms,

10. The computer-implemented method of claim 1, wherein the plurality of data acquiring programs includes a capture by file name program for searching in the particular drive for files having filepaths containing text matching chosen file names.

11. The computer-implemented method of claim 2, wherein the list of interfaces includes an evidence intake interface that allows the user to save information needed by a legal process by which evidence is acquired

12. The computer-implemented method of claim 2, wherein the list of interfaces includes a chain of custody interface that allows the user to save information needed by a legal process of maintaining a chain of custody of evidence.

13. The computer-implemented method of claim 2, wherein the list of interfaces includes an analyst notes interface that allows the user to save information needed for a manner in which data is acquired.

14. A non-transitory computer-readable storage medium comprising programming instructions of a method that are executable by a processor to acquire targeted data stored in a computing device using a data acquiring apparatus, the method comprising:
coupling the computing device to the data acquiring apparatus;
determining that the data acquiring apparatus has been recognized by the computing device;
displaying a user interface on a screen associated with the computing device, wherein the user interface lists a plurality of data acquiring programs;
determining whether a user selected one of the plurality of data acquiring programs on the user interface;
detecting a designation of a particular drive of the computing device following the user selection of the one of the plurality of data acquiring programs;
activating the selected one of the plurality of data acquiring programs to search in the designated particular drive for a data entity that corresponds to a search function of the selected one of the plurality of data acquiring programs;
generating a copy of the data entity if found by the search; and
submitting the copied data entity to a folder in the data acquiring apparatus for further processing.

15. The A non-transitory computer-readable storage medium of claim 14, further comprising:
displaying a list of interfaces for collecting desirable notes about the computing device.

16. The non-transitory computer-readable storage medium of claim 14, further comprising:
activating the selected one of the plurality of data acquiring programs to search for the data entity in all drives located in the computing device based on the determination that the user did not select one of the plurality of data acquiring programs.
